(19) United States
(12) Patent Application Publication
(10) Pub. No.: US 2025/0065501 A1
(43) Pub. Date: Feb. 27, 2025

(54) ROBOT CONTROL DEVICE AND ROBOT CONTROL METHOD

(71) Applicant: KYOCERA Corporation, Kyoto-shi, Kyoto (JP)

(72) Inventors: Ryota DOI, Yokohama-shi, Kanagawa (JP); Shosuke ONISHI, Yokohama-shi, Kanagawa (JP)

(21) Appl. No.: 18/723,816

(22) PCT Filed: Dec. 23, 2022
(86) PCT No.: PCT/JP2022/047759

§ 371 Date: Jun. 24, 2024

(30) Foreign Application Priority Data
Dec. 24, 2021 (JP) 2021-211022

(51) Int. Cl. B25J 9/16; B25J 13/08

(52) U.S. Cl. CPC B25J 9/1653; B25J 13/085

(57) ABSTRACT

A robot control device includes a controller. The controller is configured to be capable of estimating a holding manner of a holding target using each of a database and an inference model, and to control a robot based on the estimated holding manner. The database contains reference information including object information of multiple objects and holding manner information of the multiple objects. The inference model is capable of estimating a holding manner of an object. The controller acquires recognition information of a holding target. When the controller determines that the holding manner of the holding target cannot be estimated from the database based on the recognition information, the controller estimates the holding manner using the inference model.

### CROSS-REFERENCE TO RELATED APPLICATIONS

This application claims priority of Japanese Patent Application No. 2021-211022 (filed Dec. 24, 2021), the entire disclosure of which is hereby incorporated by reference.

### TECHNICAL FIELD

The present disclosure relates to a robot control device and a robot control method.

### BACKGROUND OF INVENTION

Heretofore, a known object gripping device is configured to grip an object (see Patent Literature 1, for example).

### CITATION LIST

### Patent Literature

Patent Literature 1: Japanese Unexamined Patent Application Publication No. 2017-185578

### SUMMARY

In an embodiment of the present disclosure, a robot control device includes a controller. The controller is configured to be capable of estimating a holding manner of a holding target using each of a database and an inference model. The database contains reference information including object information of multiple objects and holding manner information of the multiple objects. The inference model is capable of estimating a holding manner of an object. The controller is configured to control a robot based on the estimated holding manner. The controller is configured to acquire recognition information of a holding target. When the controller determines that the holding manner of the holding target cannot be estimated from the database based on the recognition information, the controller is configured to estimate the holding manner using the inference model.

In an embodiment of the present disclosure, a robot control method is executed by a robot control device. The robot control device is configured to be capable of estimating a holding manner of a holding target using a database and an inference model. The database contains reference information including object information of multiple objects and holding manner information of the multiple objects. The inference model is capable of estimating a holding manner of an object. The robot control device is configured to control a robot based on the estimated holding manner. The robot control method includes the robot control device acquiring recognition information of a holding target. The robot control method includes the robot control device estimating the holding manner using the inference model when the robot control device determines that the holding manner of the holding target cannot be estimated from the database based on the recognition information.

### BRIEF DESCRIPTION OF THE DRAWINGS

FIG. 1 is a schematic diagram illustrating an example configuration of a robot control system according to an embodiment.

FIG. 2 is a block diagram illustrating an example configuration of the robot control system according to an embodiment.

FIG. 3 is a table illustrating an example of reference information.

FIG. 4 is a schematic diagram illustrating points on an information acquisition sphere from which recognition information of a holding target is acquired.

FIG. 5 is a diagram illustrating an example of a holding target and feature points thereof.

FIG. 6 is a diagram illustrating an example of a candidate manner of holding a holding target.

FIG. 7 is a schematic diagram illustrating an example of reference posture information on an information acquisition sphere.

FIG. 8 is a flowchart illustrating an example procedure of a robot control method according to an embodiment.

FIG. 9 is a flowchart illustrating a robot control method including a procedure for checking category registration.

FIG. 10 is a diagram illustrating examples of clustered information acquisition points and information acquisition points picked up in each cluster.

### DESCRIPTION OF EMBODIMENTS

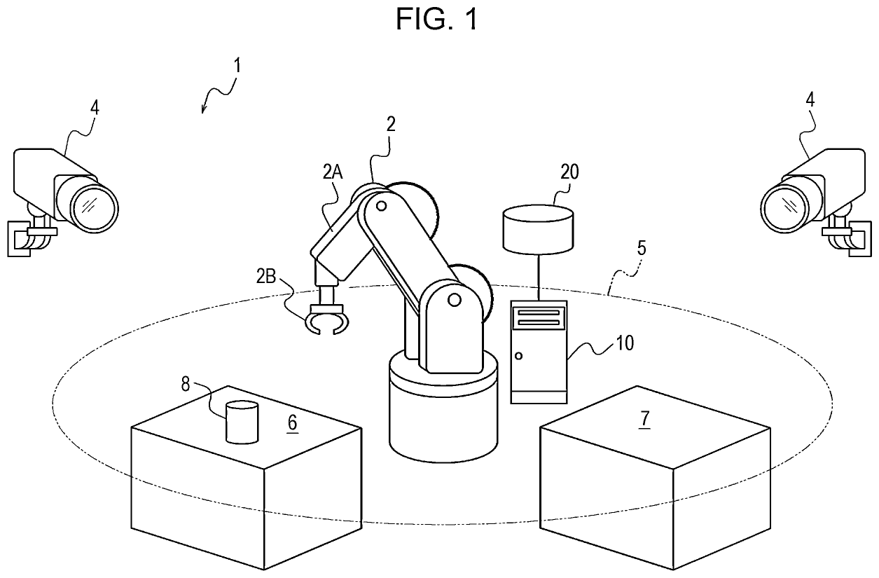

When a robot is made to hold an object, the holding position can be determined based on generic AI (Artificial Intelligence) or a rule base. If the holding position is not uniformly determined, there is a risk that secure holding or holding in accordance with the user's wishes might not be performed every time. In other words, the holding position not being determined in a uniform manner can result in holding feasibility being reduced. In the present disclosure, a robot control system 1 (see FIG. 1) can improve holding feasibility.

### Example Configuration of Robot Control System 1

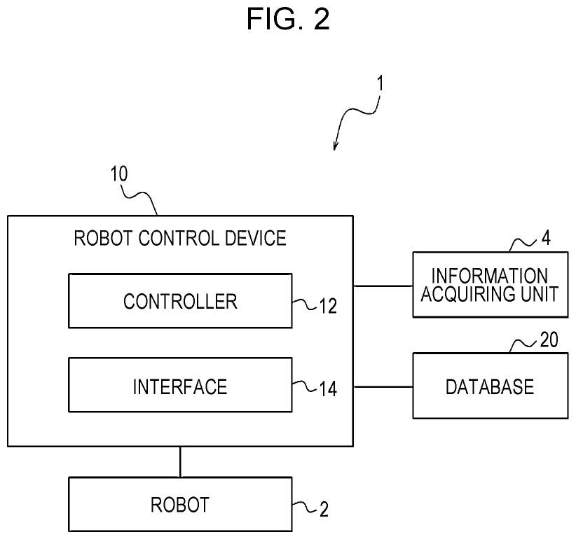

As illustrated in FIGS. 1 and 2, in an embodiment of the present disclosure, a robot control system 1 includes a robot 2, an information acquiring unit 4, a robot control device 10, and a database 20. The robot 2 is configured to be able to hold a holding target 8 using an end effector 2B. The robot control device 10 controls the robot 2 and causes the robot 2 to perform work of holding the holding target 8 using the end effector 2B. The robot control device 10 determines the positions where the robot 2 contacts the holding target 8 when the robot 2 holds the holding target 8 and the posture of the robot 2 when the robot 2 holds the holding target 8 as a holding manner based on information stored in the database 20, and outputs these pieces of information to the robot control device 10.

In this embodiment, the robot control device 10, for example, controls the robot 2 so as to cause the robot 2 to take hold of the holding target 8 at a work start bench 6. The robot control device 10, for example, controls the robot 2 so as to cause the robot 2 to move the holding target 8 from the work start bench 6 to the work destination bench 7. The holding target 8 is also referred to as a work target. The robot 2 operates inside an operation range 5.

### Robot 2

The robot 2 includes an arm 2A and the end effector 2B. The arm 2A may be configured, for example, as a six-axis or seven-axis vertically articulated robot. The arm 2A may be configured as a three-axis or four-axis horizontally articulated robot or a SCARA robot. The arm 2A may be configured as a two-axis or three-axis perpendicular robot. The arm 2A may be configured as a parallel link robot or the like. The number of axes of the arm 2A is not limited to those in the given examples. In other words, the robot 2 includes the arm 2A connected by multiple joints and is operated by driving the joints.

The end effector 2B, for example, may include a gripper configured to be able to hold the holding target 8. The gripper may include at least one finger. Fingers of the gripper may include one or more joints. The fingers of the gripper may include a suction part that holds the holding target 8 by suction. The end effector 2B may be configured as two or more fingers that hold (grip) the holding target 8 therebetween. The end effector 2B may be configured as at least one nozzle including a suction part. The end effector 2B may include a scooping hand configured to be able to scoop up the holding target 8. The end effector 2B is not limited to these examples and may be configured to be able to perform a variety of other operations. In the configuration illustrated in FIG. 1, the end effector 2B is assumed to include a gripper.

The end effector 2B may include a sensor. The sensor may include a contact force sensor that detects the contact force when the fingers of the gripper of the end effector 2B contact the holding target 8. The sensor may include a force sensor that detects the force or torque acting on the end effector 2B, the gripper, or a finger. The contact force sensor or force sensor may be configured as a piezoelectric sensor, strain gauge, or the like. The sensor may include a current sensor that detects the current flowing in a motor that drives the arm 2A, the end effector 2B, the gripper, or the fingers.

The robot control device 10 can control the position of the end effector 2B by causing the robot 2 to move the arm 2A. The end effector 2B may have axes serving as references for directions of action with respect to the holding target 8. When the end effector 2B has axes, the robot control device 10 can control the directions of the axes of the end effector 2B by causing the robot 2 to move the arm 2A. The robot control device 10 controls the robot 2 so that the end effector 2B starts and ends the operation of acting on the holding target 8. The robot control device 10 can operate the robot 2 so as to move or work on the holding target 8 by controlling the position of the end effector 2B or the directions of the axes of the end effector 2B while controlling the movement of the end effector 2B. In the configuration illustrated in FIG. 1, the robot control device 10 controls the robot 2 so as to cause the end effector 2B to take hold of the holding target 8 at the work start bench 6 and move the end effector 2B to the work destination bench 7. The robot control device 10 controls the robot 2 so as to cause the end effector 2B to release the holding target 8 at the work destination bench 7. In this way, the robot control device 10 can move the holding target 8 from the work start bench 6 to the work destination bench 7 using the robot 2.

### Information Acquiring Unit 4

The information acquiring unit 4 acquires recognition information. The information acquiring unit 4 may include a camera. The camera of the information acquiring unit 4 captures images of the holding target 8 as recognition information. The information acquiring unit 4 may include a depth sensor. The depth sensor of the information acquiring unit 4 acquires depth data of the holding target 8. The depth data may be converted to point group information for the holding target 8.

### Robot Control Device 10

As illustrated in FIG. 2, the robot control device 10 includes a controller 12 and an interface 14. The interface 14 acquires information or data about the holding target 8, etc., from an external device and outputs information or data to an external device. The interface 14 acquires images of the holding target 8 from the information acquiring unit 4. The interface 14 may accept inputs from a user. The interface 14 may output information or data to be recognize by the user. The controller 12 determines the manner in which the holding target 8 is to be held by the robot 2 based on the information or data acquired by the interface 14. The manner in which the holding target 8 is held by the robot 2 is also referred to simply as the “holding manner”. The robot control device 10 controls the robot 2 so that the robot 2 holds the holding target 8 in the determined holding manner.

The controller 12 may include at least one processor in order to provide control and processing capabilities for performing various functions. The processor may execute programs that realize various functions of the controller 12. The processor may be implemented as a single integrated circuit. An integrated circuit is also referred to as an IC. The processor may be implemented as multiple integrated circuits and discrete circuits connected so as to be able to communicate with each other. The processor may be realized based on various other known technologies.

The controller 12 may include a storage unit. The storage unit may include an electromagnetic storage medium such as a magnetic disk, or may include a memory such as a semiconductor memory or a magnetic memory. The storage unit stores various types of information. The storage unit stores programs and so forth to be executed by the controller 12. The storage unit may be configured as a non-transient readable medium. The storage unit may function as a working memory of the controller 12. At least part of the storage unit may be configured so as to be separate from the controller 12.

The interface 14 may include a communication device configured to allow wired or wireless communication. The communication device may be configured to be able to communicate using communication methods based on various communication standards. The communication device can be configured using a known communication technology.

The interface 14 may include an input device that accepts inputs such as information or data from the user. The input device may include, for example, a touch panel or touch sensor or a pointing device such as a mouse. The input device may include physical keys. The input device may include an audio input device such as a microphone.

The interface 14 includes an output device that outputs information, data, or the like to the user. The output device may include, for example, a display device that outputs visual information such as images or text or graphics. The display device may include, for example, an LCD (Liquid Crystal Display), an OLED (Electro-Luminescence) or inorganic EL display, or a PDP (Plasma Display Panel). The display device is not limited to these displays and may include a display using any of a variety of other systems. The display device may include a light-emitting device such as an LED (Light Emission Diode) or an LD (Laser Diode). The display device may include various other devices. The output device may include an audio output device such as a speaker that outputs auditory information such as a voice. The output device is not limited to these examples and may include a variety of other devices.

The robot control device 10 may be configured as a server device. The server device may include at least one computer. The server device may be configured to allow multiple computers to perform parallel processing. The server device does not need to be configured to include a physical housing, and may be configured based on a virtualization technology such as a virtual machine or a container orchestration system. The server device may be configured using a cloud service. If the server device is configured using a cloud service, a combination of managed services could be used. In other words, the functionality of the robot control device 10 can be realized as a cloud service.

The server device may include at least one server group. The server group functions as the controller 12. The number of server groups may be one or two or more. If the number of server groups is one, the functions realized by one server group encompass the functions realized by the individual server groups. The server groups are connected to each other in a wired or wireless manner so as to be able to communicate with each other.

Although the robot control device 10 is described as having a single configuration in FIGS. 1 and 2, multiple configurations may be considered and operated as a single system as needed. In other words, the robot control device 10 is configured as a platform having a variable capacity. By using multiple configurations as the robot control device 10, the system can continue to operate using other configurations even if one configuration becomes inoperable in the event of an unforeseen event such as a natural disaster. In this case, the multiple configurations are connected to each other by lines, either wired or wireless, and are configured to be able to communicate with each other. The multiple configurations may be constructed across cloud services and on-premise environments.

The robot control device 10 is connected to the robot 2 or the database 20 by a line, either wired or wireless, for example. The robot control device 10, the database 20, or the robot 2 are equipped with communication devices that use standard protocols to communicate with each other and are capable of bi-directional communication.

### Database 20

The database 20 corresponds to a storage device configured separately from the robot control device 10. The database 20 may include an electromagnetic storage medium such as a magnetic disk, or may include a memory such as a semiconductor memory or a magnetic memory. The database 20 may be configured as a HDD or SSD, etc. The database 20 stores information used to estimate the holding manner of the holding target 8, as described below. In other words, the robot control device 10 registers in the database 20 information used to estimate the holding manner of the holding target 8. The database 20 may be located in the cloud. Even if the database 20 is located in the cloud, the robot control device 10 may be located in the field, such as in a factory. The robot control device 10 and the database 20 may be configured as a single unit.

The database 20 may include at least one database group. The number of database groups may be one or two or more. The number of database groups may be increased or decreased as appropriate based on the capacity of data to be managed by the server device functioning as the robot control device 10 and the availability requirements of the server device functioning as the robot control device 10. The database groups may be connected to the server device or each server group functioning as the robot control device 10 in a wired or wireless manner so as to be able to communicate therewith.

### Example Operation of Robot Control System 1

In the robot control system 1, the robot 2 is controlled by the robot control device 10 in order to make the robot 2 perform work. In this embodiment, the work to be performed by the robot 2 includes an operation of holding the holding target 8. The controller 12 of the robot control device 10 determines the holding manner of the holding target 8 to be held by the robot 2. The controller 12 controls the robot 2 so that the robot 2 holds the holding target 8 in the determined holding manner. The holding manner includes positions at which the robot 2 contacts the holding target 8 when holding the holding target 8 and the posture of the robot 2, such as the arm or end effector, when the robot 2 holds the holding target 8.

The controller 12 acquires information by recognizing the holding target 8. The information acquired by recognizing the holding target 8 is also referred to as recognition information. The controller 12 is configured to be able to extract candidates for the holding manner of the holding target 8 based on the recognition information and information registered in the database 20, and estimate the holding manner. The means for estimating the holding manner based on the recognition information and the information registered in the database 20 is also referred to as first estimation means. The controller 12 is also configured to be able to estimate the holding manner based on an inference model that accepts the recognition information as an input and outputs an estimation result of the holding manner of the holding target 8. The means for estimating the holding manner based on the inference model is also referred to as second estimation means. When estimating the holding manner using the first estimation means, the controller 12 can estimate the holding manner at a faster processing speed or with a lighter computational load than when using the second estimation means. When using the second estimation means to estimate the holding manner, the controller 12 can estimate the holding manner with greater flexibility than when using the first estimation means.

In the robot control system 1 according to this embodiment, the controller 12 attempts to estimate the holding manner using the first estimation means. When the holding manner can be estimated using the first estimation means, the controller 12 controls the robot 2 so that the robot 2 holds the holding target 8 in the holding manner estimated using the first estimation means. When the holding manner cannot be estimated using the first estimation means, the controller 12 estimates the holding manner using the second estimation means and controls the robot 2 so that the robot 2 holds the holding target 8 in the holding manner estimated using the second estimation means.

### Information Registered in Database

As described above, when the holding manner of the holding target 8 is estimated using the first estimation means, the controller 12 estimates the holding manner of the holding target 8 based on the recognition information and information registered in the database 20. The information registered in the database 20 is information that is referred to in order to estimate the holding manner, and is also referred to as reference information. The reference information includes information that associates information indicating the holding manner of a certain object to information about that object. The information indicating the holding manner of an object is also referred to as holding manner information. The information about an object is also referred to as object information.

The controller 12 checks the object information contained in the reference information against the recognition information of the holding target 8. When object information that matches or is similar to the recognition information is included in the reference information (when such information is registered in the database 20), the controller 12 acquires the holding manner information associated with the object information that matches or is similar to the recognition information.

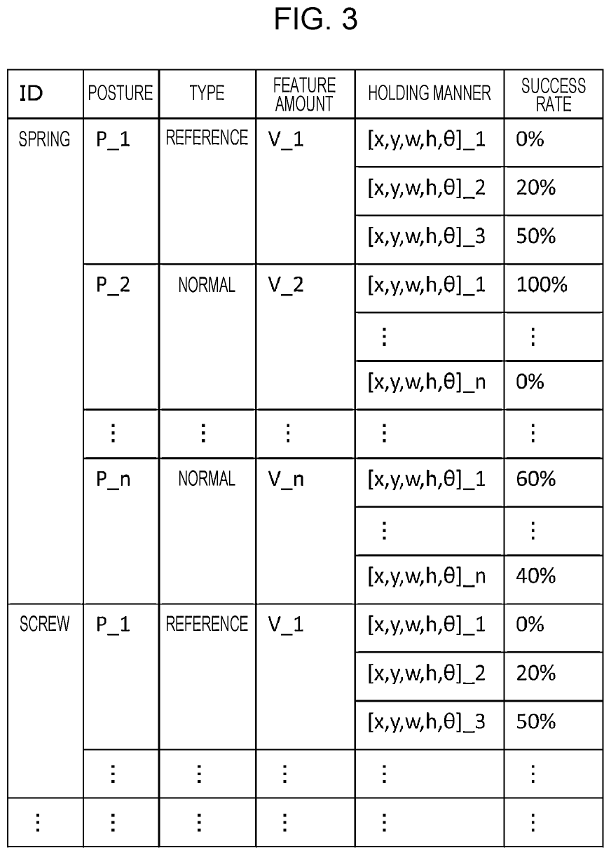

FIG. 3 illustrates an example of reference information. The reference information is described below based on the example in FIG. 3.

### Object Information

The object information may include information specifying the type of object. The “ID” column in the first column from the left in the table in FIG. 3 corresponds to the information specifying the type of object. The type of object may be a specific article name, such as spring or screw, or may be a model number. The object information of a certain object includes one piece of information that specifies the type of object.

The object information may include information specifying the posture of a visible object, as illustrated in the second column from the left in the table in FIG. 3. When the viewpoint from which an object is seen is fixed, the posture of the visible object corresponds to the posture of the object itself. When the posture of an object is fixed, the posture of the visible object depends on the viewpoint from which the object is seen (from which direction the object is seen). Information that specifies the posture of a visible object is also referred to as posture information. The posture information includes information specifying the posture of an object relative to a fixed viewpoint or information specifying the viewpoint relative to the fixed posture of an object. One object can be seen in multiple views. Therefore, one object can be seen in multiple views each specified by a corresponding one of multiple pieces of posture information. In other words, the object information of a certain object includes one or more pieces of posture information.

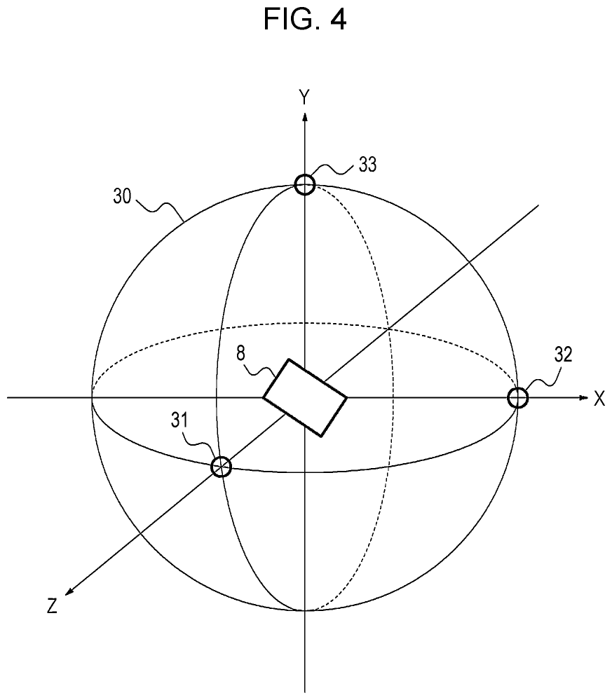

In the table in FIG. 3, the posture information is represented as P_1, P_2, or P_n. In this embodiment, the posture information can be represented by the coordinates of a point on a sphere centered on an object such as the holding target 8, as illustrated in FIG. 4 for example, so as to specify the viewpoint with respect to the fixed posture of the object. This sphere centered on an object such as the holding target 8 is also referred to as an information acquisition sphere 30. Points 31, 32, and 33 on the information acquisition sphere 30 are illustrated as examples of viewpoints from which the object is viewed. The posture information can be expressed in terms of the angle by which the object is rotated around each of the XYZ axes when the viewpoint from which an object positioned at the center of the information acquisition sphere 30 in FIG. 4 is viewed is fixed at the point 31, for example, in order to specify the posture of the object relative to a fixed viewpoint.

The object information may include the type of posture information, as illustrated in the third column from the left in the table in FIG. 3. The posture information may include base posture information and other normal posture information. The base posture information is information that specifies a point that is important as a reference for calculating the position or the direction from which the information acquiring unit 4 acquires the recognition information. The base posture information may include posture information extracted from feature amounts used to estimate the posture information using the inference model. The base posture information is posture information that is not similar to other base posture information. The normal posture information is posture information calculated after a sufficient number of pieces of posture information have been registered in the database 20. The normal posture information is information similar to at least one piece of base posture information. The normal posture information is used for supplementary purposes such as for fine tuning posture information or calculating holding performance such as success rate of holding or frequency of holding.

Object information may include information about the features of an object. Information about the features of an object is, for example, information about feature amounts that represent features of the object, as illustrated in the fourth column from the left in the table in FIG. 3. Feature amounts can vary depending on the view of the object such as the holding target 8. Therefore, when the object information includes multiple pieces of posture information, the object information includes information about feature amounts that each correspond to one of the multiple pieces of posture information.

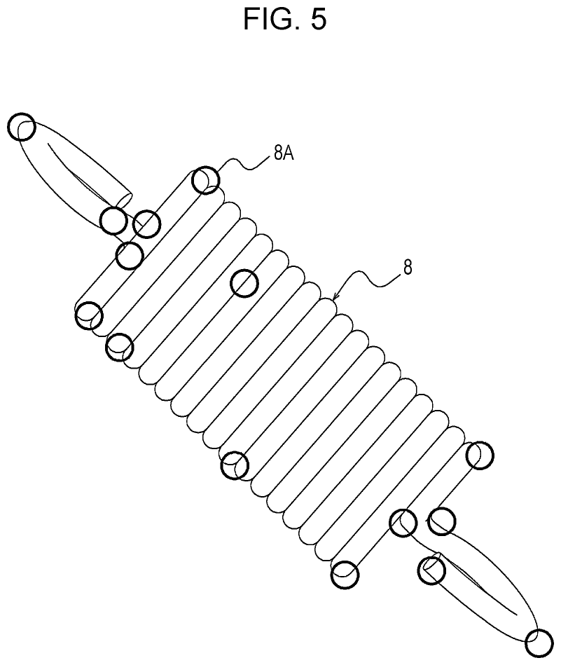

As illustrated in FIG. 5, for example, a feature amount may be a set of feature points 8A extracted from an image representing a view of an object such as the holding target 8. In this case, the feature amount may be, for example, numerical information indicating the number or distribution of the feature points 8A. The feature amount may also be the image itself representing the view of the object. Images representing views of the object may include images of an object in a particular posture captured from various viewpoints. In this case, the feature amounts may be, for example, pixel values that constitute the image. Images representing views of the object may include images in which the object is captured in various postures from a particular viewpoint. The feature amount may be a set of at least some points included in point group information of an object measured from a certain viewpoint or the point group information of the object itself. In this case, the feature amount may be, for example, numerical information indicating the number or distribution of a point group, or numerical information indicating colors or luminances included in the point group information. The feature amount may be data displayed as though modeling data of an object is viewed from a certain viewpoint. In the table in FIG. 3, the feature amounts of an object are represented as V_1, V_2, or V_n so as to respectively correspond to the posture information (P_1, P_2, or P_n).

Feature amounts can be acquired using a method such as AKAZE (Accelerated-KAZE), ORB (Orientated FAST and Rotated BRIEF), or SIFT (Scale-Invariant Feature Transform), but the feature amounts may be expressed using various other methods as well. However, in a single piece of object information, the pieces of information representing feature amounts need to be stored in the same format. The feature amounts themselves may be registered in the database 20 in their original formats or as information representing the feature amounts in other formats. Note that as another format, for example, the feature amounts may be registered in the database 20 after being restored to a 3D model using a technique such as VSLAM (Visual Simultaneous Localization and Mapping).

### Holding Manner Information

The holding manner information specifies the holding manner of an object seen in a certain view. The holding manner information may be configured to specify the holding manner using five parameters, [x, y, w, h, θ], as illustrated in the fifth column from the left in the table in FIG. 3. x and y represent the coordinates of the holding position on a plane corresponding to the view of the object. That is, x and y represent the position coordinates of the end effector 2B when holding the object. w and h represent the width and spacing of the fingers of the end effector 2B that is carrying out the holding. θ represents the angle of the fingers of the end effector 2B with respect to the object. In other words, the holding manner may be expressed in a format specifying the center positions and angle of the fingers when carrying out holding, as well as the opening width of the fingers.

The holding manner information may be configured to specify the holding manner of the object in a 6DoF (Degrees of Freedom) format. In the 6DoF format, the holding position is expressed as three-dimensional coordinates (x, y, z) and the posture of the fingers holding the object is expressed as a rotation angle (θx, θy, θz) for each of the XYZ axes. In other words, the holding manner information may be configured to specify the holding manner using six parameters, [x, y, z, θx, θy, θz], according to the 6DoF format. The holding manner information may be expressed as a grasping rectangle in the form of a polygon representing the range where the fingers of the end effector 2B are present.

The holding manner information may include a gripping force used when holding an object by gripping. The holding manner information may include information specifying the posture of the end effector 2B or fingers, etc., when holding an object. The holding manner information may include, but is not limited to, information that specifies various manners related to holding.

The holding manner information can be different for the same object depending on the view of the object. Therefore, the holding manner information is associated with the posture information. In other words, the holding manner information is associated with the object information. When one piece of object information includes multiple pieces of posture information, the holding manner information can be associated with at least some of the pieces of posture information. In other words, one or more pieces of holding manner information can be associated with a single piece of object information.

An object that is visible in one view is not limited to just one holding manner, and can have two or more holding manners. Thus, one or multiple pieces of holding manner information can be associated with a single piece of posture information. In the table illustrated in FIG. 3, three pieces of holding manner information, [x, y, w, h, θ]_1 to 3, are associated with one view of the object (P_1). In addition, n pieces of holding manner information [x, y, w, h, θ]_1 to n, are associated with one view of the object (P_2).

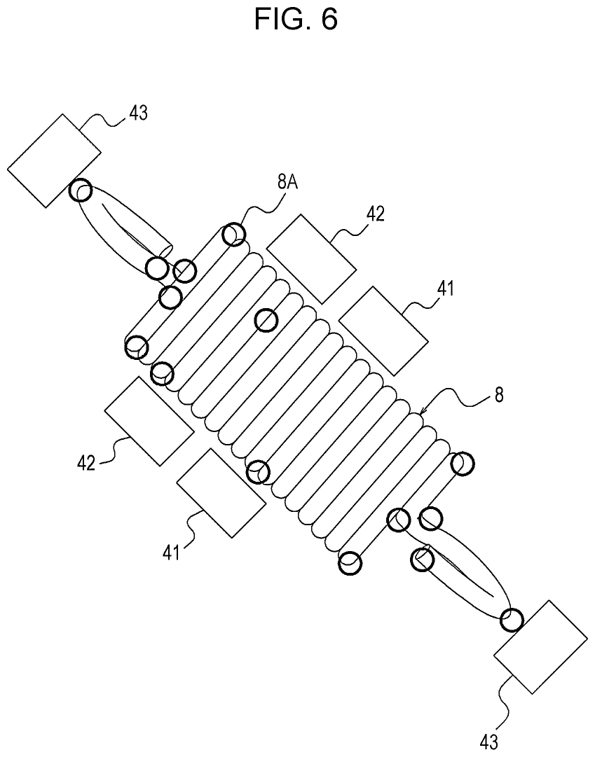

For example, as illustrated in FIG. 6, suppose that holding manner information respectively identifying a first candidate manner 41, a second candidate manner 42, and a third candidate manner 43, as candidates of a manner of holding an object such as the holding target 8, are associated with the posture information of holding target 8 in the image in FIG. 6. The first candidate manner 41 corresponds to the position of the two fingers when the holding target 8, which is a cylindrical spring, is held by being pinched in the diameter direction of the cylindrical spring (in the transverse direction of the spring, which looks rectangular in plan view) at a position near the center of the cylindrical spring. The second candidate manner 42 corresponds to the position of the two fingers when the holding target 8 is held by being pinched in the diameter direction at an off-center position. The third candidate manner 43 corresponds to the position of the two fingers when the holding target 8, which is a cylindrical spring, is held by being pinched in the axial direction of the cylindrical spring (longitudinal direction of the spring, which looks rectangular in plan view). In the holding manner information specifying each candidate manner, x and y represent the coordinates of the midpoint of the positions of the two fingers in the image plane representing the view of the object serving as the holding target 8. w and h represent the width of the fingers and the distance between the two fingers. θ represents the angle at which the direction in which the two fingers are arrayed is rotated around a normal to the image plane. Assuming that the view represented by P_1 in the table illustrated in FIG. 3 corresponds to the image illustrated in FIG. 6, the three pieces of holding manner information ([x, y, w, h, θ]_1 to 3) associated with P_1 could be information respectively representing the first to third candidate manners 41 to 43.

The holding manner information may include the success rate of holding an object in each holding manner, as illustrated in the sixth column from the left in the table in FIG. 3. The success rate is calculated based on the success or failure of actually holding the object in the various holding manners in each view of the object. As discussed below, the controller 12 may estimate the holding manner based on the success rate.

### Acquiring Recognition Information

The controller 12 acquires recognition information of the holding target 8 in order to estimate the holding manner of the holding target 8. The recognition information may include information about features of the holding target 8. The controller 12 may, for example, acquire information about the feature points 8A of the holding target 8 as information about the features of the holding target 8. Specifically, feature amounts of the holding target 8 may be acquired. The controller 12 may acquire an image of the holding target 8 captured by a camera, extract the feature points 8A from the image, and acquire the feature points 8A as recognition information including feature amounts of the holding target 8. The controller 12 may acquire point group information of the holding target 8 detected by the depth sensor, extract the feature points 8A from the point group information, and acquire the feature points 8A as recognition information including the feature amounts of the holding target 8. The controller 12 may acquire an image or point group information of the holding target 8 as recognition information that includes the feature amounts of the holding target 8.

As described below, the controller 12 checks the reference information registered in the database 20 and determines whether object information that matches or is similar to the recognition information is registered in the database 20. The controller 12 may acquire the recognition information in a format that can be compared to object information. For example, if the object information includes feature amounts, the controller 12 may acquire the feature amounts of the holding target 8 as recognition information. In this case, the controller 12 may determine whether object information that matches or is similar to the recognition information is registered in the database 20 by comparing the feature amounts of the object information with the feature amounts of the recognition information. If the object information includes posture information, the controller 12 may acquire the posture information of the holding target 8 as recognition information. The posture information may include information about the features of the posture of the holding target 8.

When the position or direction from which the recognition information of the holding target 8 is acquired by the information acquiring unit 4 is fixed, the controller 12 may estimate the posture of the holding target 8 based on the recognition information of the holding target 8 and generate posture information. The controller 12 may estimate the posture of the holding target 8 and generate posture information based on information about the features of the holding target 8, information specifying the position of the information acquiring unit 4, and so on.

As recognition information of the holding target 8, the controller 12 may acquire posture information that specifies the position or direction from which the information acquiring unit 4 acquires the recognition information of the holding target 8. The controller 12 may estimate the posture information of the position or direction from which the information acquiring unit 4 acquires the recognition information based on the recognition information of the holding target 8 and generate the posture information. The controller 12 may use a posture estimation method such as epipolar geometry to estimate the posture information of the position or direction from which the information acquiring unit 4 acquires the recognition information.

The controller 12 may fine-tune the estimation result of the posture information of the position or direction from which the information acquiring unit 4 acquires the recognition information. The controller 12 may fine-tune the estimation result of the posture information with a method in which surrounding image-capturing points are used. In this case, the controller 12 fine-tunes the posture information by extracting posture information from around the estimated posture information from among the posture information registered in the database 20 and estimating the posture information using feature amounts associated with the extracted posture information. The controller 12 may fine-tune the estimation result of the posture information using a method in which all image-capturing points are used. In this case, the controller 12 fine-tunes the estimation result of the posture information while searching all the posture information registered in the database 20.

### Determination of Holding Manner by Checking Reference Information

The controller 12 checks the reference information registered in the database 20 and compares the recognition information with the object information contained in the reference information in order to determine whether object information that matches or is similar to the recognition information is registered in the database 20. If the object information includes feature amounts, the controller 12 may compare the feature amounts acquired as recognition information with the feature amounts included in the object information.

If the object information includes posture information, the controller 12 may compare the posture information of the holding target 8 acquired as recognition information with the posture information included in the object information. If the posture information includes feature amounts of posture, the controller 12 may compare the feature amounts acquired as recognition information with the feature amounts included in the object information.

### Estimation of Holding Manner Using Database 20

If there is reference information that contains object information that matches or is similar to the recognition information among the reference information registered in the database 20, the controller 12 determines that the database 20 can be used to estimate the holding manner of the holding target 8. The controller 12 acquires, from the database 20, the holding manner information associated with the object information that matches or is similar to the recognition information.

### When there is Object Information that Matches Recognition Information

When reference information including object information that matches the recognition information is registered in the database 20, the controller 12 acquires the holding manner information associated with the object information that matches the recognition information. The controller 12 may estimate the holding manner specified by the acquired holding manner information as the holding manner of the holding target 8. If multiple pieces of holding manner information are associated with the object information that matches the recognition information, the controller 12 acquires the multiple pieces of holding manner information. The controller 12 may select one piece of holding manner information from among the multiple pieces of holding manner information and estimate the holding manner specified by the selected holding manner information as the holding manner of the holding target 8. The controller 12 may, for example, select one piece of holding manner information based on the holding performance associated with each of the multiple pieces of holding manner information. The controller 12 may select the holding manner information having the best holding performance. The controller 12 may select the holding manner information having the highest success rate as the holding manner information having the best holding performance The controller 12 may select the holding manner information having the highest holding frequency as the holding manner information having the best holding performance.

For example, the controller 12 acquires the probability of successful holding (success rate) for when holding is carried out in each candidate manner illustrated in FIG. 6. The success rate when holding is carried out in the first candidate manner 41 is assumed to be 90%. The success rate when holding is carried out in the second candidate manner 42 is assumed to be 60%. The success rate when holding is carried out in the third candidate manner 43 is assumed to be 40%. The controller 12 may select the holding manner information that specifies the candidate manner having the highest success rate. In this case, the controller 12 may select the holding manner information that specifies the first candidate manner 41. The controller 12 may acquire the holding frequency instead of the success rate and select the holding manner information that specifies the candidate manner having the highest holding frequency.

### When there is Object Information Similar to Recognition Information

When reference information including object information that is similar to the recognition information is registered in the database 20, the controller 12 acquires the holding manner information associated with the object information that is similar to the recognition information. In other words, the controller 12 may be configured to search the database 20 for object information that is similar to the recognition information and extract holding manners associated with the retrieved object information.

The controller 12 may determine that the recognition information and the object information are similar to each other when a numerical value representing the difference between the recognition information and the object information is less than a prescribed threshold. For example, the controller 12 may calculate the difference between the posture information of the holding target 8 and the posture information contained in the object information as a numerical value, and determine that the recognition information and the object information are similar to each other when the calculated numerical value is less than the prescribed threshold. If the posture information is expressed as a parameter in a spherical coordinate system, the controller 12 may calculate the difference between the parameter of the posture information of the holding target 8 and the parameter of the posture information contained in the object information. If the posture information is expressed as a rotation angle around a prescribed axis, the controller 12 may calculate the difference between the rotation angle representing the posture information of the holding target 8 and the rotation angle representing the posture information contained in the object information.

Specifically, the controller 12 may calculate the difference between a feature amount of the holding target 8 and a feature amount contained in the object information as a numerical value, and determine that the recognition information and the object information are similar to each other when the calculated value is less than a prescribed threshold. When the feature amount is a set of feature points, the controller 12 may calculate the difference between the number of feature points of the holding target 8 and the number of feature points contained in the object information. The controller 12 may calculate the difference between the coordinates of a feature point of the holding target 8 and the coordinates of a feature point contained in the object information. When the feature amount is point group information representing the holding target 8, the controller 12 may calculate the difference between the number of points included in the point group information representing the holding target 8 and the number of points included in the point group information representing the object in the object information. The controller 12 may calculate the difference between the coordinates of each point included in the point group information representing the holding target 8 and the coordinates of the corresponding point in the point group information representing the object included in the object information. When the feature amount is an image of an object, the controller 12 may calculate the difference between an image of the holding target 8 and an image of the object specified by the object information.

If the number of pieces of object information similar to the recognition information is one, the controller 12 acquires the holding manner information associated with that one piece of object information. The controller 12 may estimate the holding manner specified by the acquired holding manner information as the holding manner of the holding target 8. When multiple pieces of holding manner information are associated with one piece of object information, the controller 12 may select one piece of holding manner information from among the multiple pieces of holding manner information and estimate the holding manner specified by the selected holding manner information as the holding manner of the holding target 8.

When multiple pieces of object information are similar to the recognition information, the controller 12 may acquire the holding manner information associated with each of the multiple pieces of object information. When the controller 12 acquires multiple pieces of holding manner information, the controller 12 may select one piece of holding manner information from among the multiple pieces of holding manner information and estimate the holding manner specified by the selected holding manner information as the holding manner of the holding target 8.

When selecting one piece of holding manner information from among multiple pieces of holding manner information, regardless of whether the number of pieces of object information is one or more, the controller 12 may select one piece of holding manner information based on the success rate associated with each of the multiple pieces of holding manner information. The controller 12 may select the holding manner information having the highest success rate.

As mentioned above, even if object information that matches the recognition information is not registered in the database 20, the controller 12 may estimate the holding manner based on holding manner information associated with object information that is similar to the recognition information. Even if object information that matches the recognition information is not registered in the database 20, the controller 12 may estimate holding manner information associated with object information matching the recognition information based on multiple pieces of object information similar to the recognition information and holding manner information associated with each of those pieces of object information.

For example, if the recognition information of the holding target 8 includes posture information, the controller 12 determines whether posture information in the vicinity of the posture information of the holding target 8 on the information acquisition sphere 30 is registered in the database 20. For example, the controller 12 may determine that posture information specifying a point on the information acquisition sphere 30 positioned within a prescribed distance (within a prescribed range) from the point specified by the posture information is vicinity posture information. Vicinity posture information is also referred to as reference posture information.

When posture information (reference posture information) in the vicinity of the posture information of the holding target 8 is registered in the database 20, the controller 12 acquires, from the database 20, the holding manner information associated with each of the multiple pieces of reference posture information. Based on the holding manner information associated with the reference posture information, the controller 12 can perform interpolation and generate holding manner information estimated to be associated with the posture information of an object matching the posture information of the holding target 8. Based on the interpolated and generated holding manner information, the controller 12 can estimate the holding manner in the posture specified by the posture information of the holding target 8.

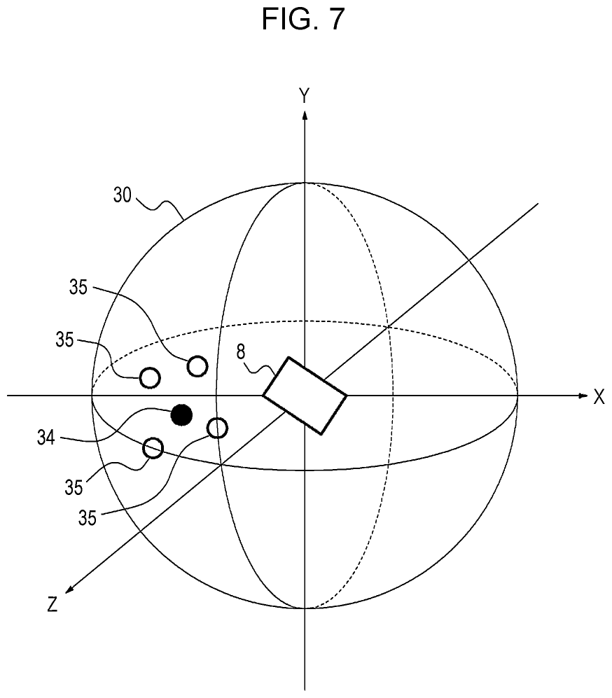

A specific example of interpolation is described below with reference to FIG. 7. The controller 12 acquires the recognition information generated by recognizing the holding target 8 from a point 34 on the information acquisition sphere 30. The recognition information includes posture information specifying the point 34. Let us suppose that no reference information including posture information specifying the point 34 is registered in the database 20. On the other hand, let us assume that reference information including posture information specifying points 35 positioned in the vicinity of the point 34 is registered. In other words, let us assume that although posture information that matches the posture information of the holding target 8 is not registered in the database 20, posture information in the vicinity of the posture information of the holding target 8 (reference posture information) is registered in the database 20.

The controller 12 acquires holding manner information associated with object information including posture information specifying each of the four points 35. Assume that the posture information specifying the points 35 is associated with the three pieces of holding manner information respectively specifying the first candidate manner 41, second candidate manner 42, and third candidate manner 43 in FIG. 6. In this case, the three pieces of holding manner information respectively identifying the first candidate manner 41, the second candidate manner 42, and the third candidate manner 43 are presumed to be associated with the posture information identifying the point 34. The controller 12 can select any one of the first candidate manner 41, the second candidate manner 42, and the third candidate manner 43 as the holding manner of the holding target 8.

The controller 12 may select a holding manner for the holding target 8 from among the first candidate manner 41, the second candidate manner 42, and the third candidate manner 43 based on the success rate of holding realized by each manner. For example, suppose that the success rates of holding for the first candidate manner 41 at the four points 35 are 90%, 90%, 100%, and 80%, respectively. In this case, the controller 12 may regard the success rate of holding for the first candidate manner 41 at the point 34 to be 90%, which is the average of the success rates of holding at the four points 35. Suppose that the success rates of holding for the second candidate manner 42 at the four points 35 are 60%, 70%, 70%, and 70%, respectively. In this case, the controller 12 may regard the success rate of holding for the second candidate manner 42 at the point 34 to be 67%, which is the average of the success rates of holding at the four points 35. Suppose that the success rates of holding for the third candidate manner 43 at the four points 35 are 40%, 30%, 40%, and 0%, respectively. In this case, the controller 12 may regard the success rate of holding for the third candidate manner 43 at the point 34 to be 37%, which is the average of the success rates of holding at the four points 35.

Even when information is acquired from the point 34, the controller 12 may regard the success rate of holding of the first candidate manner 41 as being higher than those of the second candidate manner 42 and the third candidate manner 43 and determine the first candidate manner 41 as the holding manner of the holding target 8. Otherwise, the controller 12 may determine the holding manner by regarding the holding success rate of any one of the points 35 positioned in the vicinity of the point 34 as the holding success rate of the point 34 as it is.

As described above, even if object information that matches the recognition information is not registered in the database 20, the controller 12 can perform interpolation using object information in the vicinity of object information that matches the recognition information. In this way, the holding manner of the holding target 8 can be easily determined based on the database 20.

If multiple pieces of object information that match or are similar to the recognition information are registered in the database 20, the controller 12 may acquire the holding manner information associated with each piece of object information. The controller 12 may select one piece of object information from among the multiple pieces of object information and acquire the holding manner information associated with the selected object information. The controller 12 may calculate the degree of matching between the recognition information and each of the multiple pieces of object information, select the object information having the highest degree of matching, and acquire the holding manner information associated with the selected object information.

If multiple pieces of holding manner information are associated with the object information that matches or is similar to the recognition information, the controller 12 may select and acquire one piece of holding manner information from among the multiple pieces of holding manner information. The controller 12 may select the holding manner information based on the success rate associated with the holding manner information. For example, in the reference information illustrated in the table in FIG. 3, object information indicating that the holding target 8 is a spring and that the view of the spring is P_1 is associated with three pieces of holding manner information respectively represented as [x, y, w, h, θ]_1 to 3. Here, the success rates associated with the pieces of holding manner information are 0%, 20%, and 50%, respectively. The controller 12 may select the holding manner information represented as [x, y, w, h, θ]_3, which is associated with the highest success rate (50%) among these pieces of holding manner information.

The controller 12 estimates the holding manner of the holding target 8 based on the acquired holding manner information. When the controller 12 acquires one piece of holding manner information, the controller 12 may estimate the manner specified by the holding manner information as the holding manner of the holding target 8. When the controller 12 acquires one or more pieces of holding manner information, the controller 12 may estimate the holding manner of the holding target 8 based on the holding manner information. When the controller 12 acquires multiple pieces of holding manner information, the controller 12 may estimate the holding manner of the holding target 8 based on the success rate associated with each piece of holding manner information. The controller 12 may select one piece of holding manner information from among the multiple pieces of holding manner information based on the success rates and estimate the holding manner of holding target 8 based on the selected holding manner information.

As described above, in the estimation of the holding manner using the database 20, the reference information includes posture information for each of multiple objects and holding manner information associated with the posture information. The controller 12 may acquire the posture information of the holding target 8 as recognition information and estimate the holding manner of the holding target 8 based on the acquired posture information of the holding target 8. The controller 12 may estimate the holding manner of the holding target 8 based on at least one piece of holding target information associated with reference posture information similar to the posture information of the holding target 8. The controller 12 may estimate the holding manner based on multiple pieces of holding manner information associated with each of multiple pieces of reference posture information that are similar to the posture information. When multiple pieces of holding manner information are associated with a single piece of reference posture information, the controller 12 may select the associated holding manner information having the highest success rate from among the multiple pieces of holding manner information and estimate the holding manner of the holding target 8.

### Estimating Holding Manner Using Inference Model

If no object information that matches or is similar to the recognition information is registered in the database 20, the controller 12 estimates the holding manner of the holding target 8 using an inference model. In other words, the controller 12 estimates the holding manner of the holding target 8 by using the inference model when no object information resembling the recognition information is registered in the database 20. The inference model is configured to accept recognition information as an input and output an estimation result of the holding manner of the holding target 8. Inference models may include models generated by machine learning, such as deep learning. The inference model may be configured to estimate the holding manner based on AI (Artificial Intelligence) techniques. The inference model may be configured to estimate the holding manner using a rule base. If configured to estimate the holding manner using a rule base, holding feasibility or certainty may be improved compared to AI. A 3D model may be used as the inference model. The inference model may be configured to estimate the holding manner using a variety of methods, not limited to these example configurations. The robot control device 10 may include different types of inference models.

Input information such as recognition information used in the estimation of a holding target based on a database inquiry (first estimation means) and recognition information used in estimation of a holding manner based on an inference model (second estimation means) may be the same information. When the holding manner is estimated using an inference model, the inference model may be configured to output an estimation result in a format that can be compared to database inquiries or information input to the inference model. Specifically, an estimation result output from the inference model can be treated as reference information in a database inquiry, and in this embodiment, the data format is such that the feature amounts of input information and reference information can be compared in a database query.

### Determination of Holding Manner Based On Estimation Results

The controller 12 determines the holding manner of the holding target 8 based on estimation results of the holding manner obtained using the database 20 or estimation results of the holding manner obtained using the inference model. The controller 12 may determine the estimation result of the holding manner as it is as the holding manner. The controller 12 may generate a holding manner based on the estimation result of the holding manner and determine the generated manner as the holding manner. The controller 12 may determine a holding manner obtained by modifying or changing the estimation result of the holding manner as the holding manner. If the format of a holding manner estimated using the database 20 is different from the format of a holding manner estimated using the inference model, the controller 12 may convert the holding manners to be in the same format. The controller 12 may convert the holding manner estimated using the database 20 or the inference model to match the format of a holding manner used to control the robot 2.

### Operation Based On Determined Holding Manner

The controller 12 controls the robot 2 so as to cause the robot 2 to hold the holding target 8 in the determined holding manner. The controller 12 acquires whether the robot 2 successfully performed holding as a holding result.

### Registration of Holding Result

When the controller 12 estimates the holding manner of the holding target 8 from the inference model, the controller 12 may be configured to be able to register the estimation result in the database 20. The controller 12 may be configured to control the robot 2 based on the estimation result of the holding manner of the holding target 8 obtained from the inference model and register the estimation result in the database 20 when the holding target 8 is successfully held in the holding manner corresponding to the employed estimation result. For example, when the holding target 8 is successfully held in the holding manner determined based on the estimation result of the holding manner acquired from database 20, the controller 12 may update the success rate associated with the holding manner information registered in the database 20. When the holding target 8 is successfully held in the holding manner determined based on the estimation result of the holding manner acquired from the inference model, the controller 12 may generate reference information associating the holding manner information representing the successful holding manner with the object information of the holding target 8 and register this information in the database 20. In this case, the database 20 is constructed based on the successful holding manners, and therefore the reliability of the estimation results of the holding manner can be improved by introducing the database 20.

Each time the controller 12 acquires the result of one successful holding of one holding target 8, the controller 12 may register the holding manner information representing the successful holding manner in the database 20. The controller 12 may summarize the results of successful holdings of multiple holding targets 8 in the database 20 and register the holding manner information representing the successful holding manners in the database 20, and the controller 12 may summarize the results of multiple successful holding of a single holding target 8 and register the holding manner information representing the successful holding manners in the database 20. The controller 12 may extract some results based on the number of pieces of posture information corresponding to successful holding or the density of points representing posture information on the information acquisition sphere 30, and register the holding manner information including only posture information corresponding to the extracted results in the database 20.

The controller 12 may update the success rate associated with the holding manner information so as to decrease the success rate when holding in the manner specified by the holding manner information registered in the database 20 is not successful. Even if holding in a manner not registered in the database 20 is not successful, the controller 12 may register a success rate associated with holding manner information specifying the manner in the database 20 as 0%.

When posture information that matches or is similar to the recognition information is not registered in the database 20, and the controller 12 determines a holding manner for the posture information and acquires a holding result, the controller 12 may register that posture information in the database 20 as base posture information. The controller 12 may register multiple pieces of base posture information. When the controller 12 determines a holding manner and acquires a holding result for posture information that is similar to the recognition information and has been registered in the database 20, the controller 12 may register that posture information in the database 20 as normal posture information. The controller 12 may register multiple pieces of normal posture information.

### Determination of Successful Holding

The controller 12 may determine whether holding is successful based on detection results of sensors of the robot 2. The controller 12 may estimate the holding state of the holding target 8 using the end effector 2B. A state in which the end effector 2B normally holds the holding target 8 is also referred to as a holding normal state. The holding state is presumed to be a holding normal state when the end effector 2B is able to hold the holding target 8 without the holding target 8 slipping from the gripper or fingers. Conversely, the holding state is presumed not to be a holding normal state when the holding target 8 slips or falls from the gripper or fingers.

The controller 12 may estimate the holding state based on position information of the end effector 2B. For example, the controller 12 may estimate that the holding state is the holding normal state when the position at which the gripper or fingers, etc. of the end effector 2B hold the holding target 8 is within a prescribed distance from a position specified in the holding manner. The controller 12 may estimate that the holding state is the holding normal state when the force or torque acting on the end effector 2B according to a contact force sensor or a force sensor is within a prescribed range.

If the contact force sensor or force sensor does not detect any force or torque acting on the end effector 2B, etc., even though the position at which the gripper or fingers, etc. of the end effector 2B holds the holding target 8 is within a predetermined distance from the position specified in the holding manner, the controller 12 may estimate that the holding state is not a holding normal state. If the value of the force or torque detected by the contact force sensor or force sensor is outside the prescribed range, the controller 12 may estimate that the holding state is not the holding normal state. Conversely, the holding state may be estimated to be a normal state if the conditions for estimating that the holding state is not a holding normal state are not met.

The controller 12 may continuously estimate the holding state while the end effector 2B is holding the holding target 8 (from the start to the end of holding), or may estimate the holding state at prescribed intervals, or may estimate the holding state at an irregular timing. The controller 12 may determine that holding was successful when the controller 12 continuously estimates that the holding state is the holding normal state while the end effector 2B is holding the holding target 8. The controller 12 may determine that holding was not successful when the controller 12 estimates, one or more times, that the holding state is not the holding normal state while the end effector 2B is holding the holding target 8. Conversely, the controller 12 may determine that holding was successful when the controller 12 did not estimate that the holding state was not the holding normal state while the end effector 2B was holding the holding target 8.

### Example Procedure of Robot Control Method

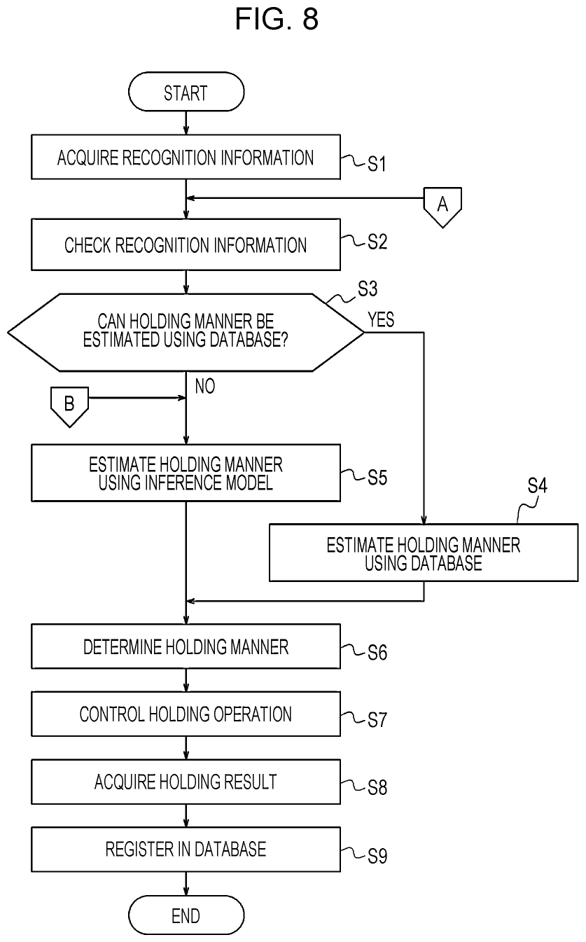

The controller 12 may perform the operations described above as a robot control method that includes the procedures of the flowchart illustrated in FIG. 8. The robot control method may be realized as a robot control program to be executed by a processor constituting the controller 12. The robot control program may be stored on a non-transitory computer-readable medium.

The controller 12 acquires recognition information of the holding target 8 (Step S1). The controller 12 checks the reference information (Step S2). Based on the result of checking the reference information, the controller 12 determines whether the holding manner can be estimated using the database 20 (Step S3).

When the controller 12 determines that the holding manner can be estimated using the database 20 (Step S3: YES), the holding manner is estimated using the database 20 (Step S4). In this case, the controller 12 estimates the holding manner based on holding manner information acquired from the database 20. After the procedure of Step S4, the controller 12 proceeds to the procedure of Step S6.

When the controller 12 determines that the holding manner cannot be estimated using the database 20 (Step S3: NO), the controller 12 estimates the holding manner using an inference model (Step S5). In this case, the controller 12 estimates the holding manner by inputting the recognition information to the inference model and acquiring an estimation result of the holding manner from the inference model. After the procedure of Step S5, the controller 12 proceeds to the procedure of Step S6.

The controller 12 determines the holding manner of the holding target 8 based on the holding manner estimated by the database 20 or the inference model (Step S6). The controller 12 controls the robot 2 to perform the holding operation in the determined holding manner (Step S7). The controller 12 acquires a holding result realized by the robot 2 (Step S8). The controller 12 registers the new reference information or updated reference information in the database 20 (Step S9). After execution of the procedure of Step S9, the controller 12 completes execution of the procedures of the flowchart in FIG. 8.

### Summary

As described above, with the robot control device 10 or the robot control method according to this embodiment, the holding position is determined based on a comparison between object information registered in the database 20 and recognition information, but if no information that matches or is similar to the recognition information is registered in the database 20, the holding position is determined based on the inference model. In other words, the controller 12 uses the first estimation means to estimate the holding manner of the holding target 8, but uses the second estimation means to estimate the holding manner of the holding target 8 when the holding manner cannot be estimated using the first estimation means.

Here, as a comparative example, a method can be considered in which a holding position is determined after registering recognition information in a database, when no information that matches or is similar to the recognition information is registered in the database. However, a large workload and time are required to register new recognition information in the database. Therefore, in the comparative example, the holding position of a holding target not yet registered in the database is not easily determined.

On the other hand, according to this embodiment, the controller 12 of the robot control device 10 is configured to be able to estimate the holding manner of the holding target 8 by using each of the database 20, in which reference information including object information of multiple objects and holding manner information of multiple objects is stored, and the inference model capable of estimating the holding manner of objects. The controller 12 is configured to control the robot 2 based on the estimated holding manner. The controller 12 acquires recognition information of the holding target 8, and if the controller 12 determines that the holding manner of the holding target 8 based on the recognition information cannot be estimated from the database 20, the controller 12 estimates the holding manner using the inference model. In other words, according to this embodiment, the robot control device 10 or the robot control method can determine the holding position of the holding target 8 based on the inference model when the holding target 8 is not yet registered in the database 20. The holding position of holding target 8 is easily determined by changing the algorithm for determining the holding position. In this way, both the speed of the estimation processing of the holding manner can be increased and the flexibility of the estimation processing of the holding manner can be ensured. As a result, the holding feasibility can be improved. In addition, the convenience of the robot 2 holding the holding target 8 can be improved.

In the above example, an example is described in which the second estimation means is used to estimate the holding manner of the holding target 8 when the holding manner cannot be estimated using the first estimation means. Not limited to this example, the second estimation means may be used to estimate the holding target when the holding target 8 cannot not be held in the holding manner estimated by the first estimation means.

### Other Embodiments

Other embodiments are described below.

### Method of Referring to Category of Holding Target 8

The controller 12 may determine whether the holding manner can be estimated based on the database 20 by referring to a category of the holding target 8. For example, the holding manner can vary depending on whether the holding target 8 is a bolt or a spring. The holding manner can also vary depending on whether the holding target 8 is a bolt, which is an industrial component, or a ballpoint pen, which is a piece of stationery. However, the controller 12 might not be able to identify the type of the holding target 8 based solely on the feature amounts of the holding target 8. If the holding target 8 is a bolt but the controller 12 recognizes the holding target 8 as another object such as a spring or a ballpoint pen, the estimated holding manner might not be appropriate. Therefore, the recognition accuracy of the type of the holding target 8 can be improved by referring to the category of the holding target 8. As a result, the holding target 8 can be properly held.

In other words, the reference information may include category information indicating the category of each of multiple objects. The controller 12 may be configured to acquire category information of the holding target 8 and to estimate the holding manner from the database 20 based on object information including the category information retrieved from the reference information stored in the database 20. The controller 12 may be configured to estimate the holding manner of the holding target 8 using the inference model when the category information of the holding target 8 is not registered in the database 20.

Specifically, the controller 12 may acquire information specifying the category of the holding target 8 as well as feature amounts of the holding target 8 as recognition information of the holding target 8. The information specifying the category of holding target 8 is also referred to as category information. The category may correspond to the type of the holding target 8. The category information may include, for example, classification information indicating that the holding target 8 is an industrial component or a piece of stationery, etc. Category information may include, for example, individual information constituting the classification information. Individual information refers, for example, to a bolt or a nut if the classification information is for an industrial component, or refers to a pencil or an eraser if the classification information is for stationery. The controller 12 may acquire classification information or individual information. The category information may be the name of an object or an ID or number assigned to the object. The category information may correspond to the ID cell in the first column from the left in the table in FIG. 3, which illustrates the reference information. The category information may be acquired through user input.

When acquiring category information of the holding target 8, the controller 12 checks the reference information of the database 20 and determines whether reference information including the same category information is registered in the database 20. If the same category information as the holding target 8 is not registered in the database 20, the controller 12 may determine that the holding manner of the holding target 8 cannot be estimated using the database 20 and may instead estimate the holding manner using the inference model. If the same category information as the holding target 8 is registered in the database 20, the controller 12 may continue checking the feature amounts of the holding target 8 against the feature amounts contained in the reference information. The controller 12 may estimate the holding manner by using the database 20 when reference information containing feature amounts that match or are similar to the feature amounts of the holding target 8 is registered in the database 20. The controller 12 may estimate the holding manner by using the inference model when reference information containing feature amounts that match or are similar to the feature amounts of the holding target 8 is registered in the database 20.

When AI or template matching or another method is used in advance to recognize the holding target 8, the controller 12 may estimate information such as a label or category that indicates what kind of object the holding target 8 is. In other words, the controller 12 may estimate the category information of the holding target 8. The category information can be included in the recognition information of the holding target 8. When the controller 12 acquires recognition information of the holding target 8, the controller 12 may use the category information contained in the recognition information to determine whether recognition of the holding target 8 using AI or template matching, etc., has been performed in advance. The controller 12 may proceed to checking feature amounts when recognition of the holding target 8 using AI or template matching, etc., has been performed in advance. If recognition of the holding target 8 using AI or template matching, etc., has not been performed in advance, the controller 12 may proceed to estimating the holding target using the inference model.

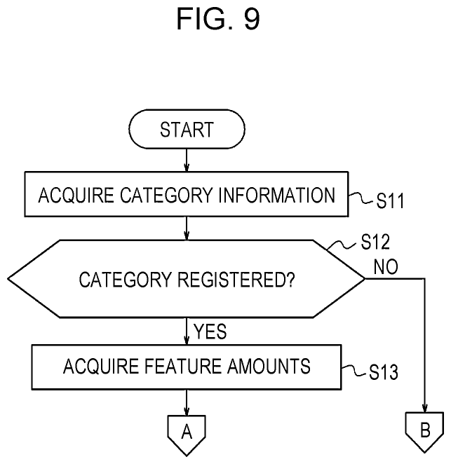

The controller 12 may perform the procedures illustrated in the flowchart of FIG. 9, as a procedure for referencing the category of the holding target 8, before performing the robot control method that includes the procedures illustrated in the flowchart of FIG. 8.

The controller 12 acquires category information of the holding target 8 (Step S11). The controller 12 determines whether the acquired category information is registered in the database 20 (Step S12). When the acquired category information is not registered in the database 20 (Step S12: NO), the controller 12 determines that the holding manner cannot be estimated using the database 20 and proceeds to the procedure of estimating the holding manner using the inference model in Step S5 of FIG. 8. When the acquired category information is registered in the database 20 (Step S12: YES), the controller 12 acquires the feature amounts of the holding target 8 (Step S13) and proceeds to the procedure of checking the reference information in Step S2 of FIG. 8.

If the recognition information of the holding target 8 can match or be similar to the object information registered in the database 20, specifically, for example, if the feature amounts of the holding target 8 can match or be similar to multiple feature amounts included in the object information registered in the database 20, the accuracy of checking based on feature amounts may decrease. The accuracy of checking based on feature amounts can be improved by checking the category of the holding target 8.

### Clustering

The controller 12 may integrate multiple similar pieces of reference information registered in the database 20. For example, the controller 12 may be configured to cluster pieces of reference information registered in the database 20 and perform integration processing on at least two pieces of reference information contained in each cluster. The integration processing may include deletion processing of deleting the reference information that exists prior to the integration. When the reference information includes reference posture information, the controller 12 may be configured to cluster the reference posture information registered in the database 20 and perform integration processing on at least two pieces of the reference posture information included in each cluster. The integration processing may include deletion processing of deleting the reference posture information that exists prior to the integration. Integration processing can reduce the amount of data in the database 20. In addition, the workload incurred when checking the database 20 can be reduced. The integrated reference information is also referred to as integrated information. The integrated reference posture information is also referred to as integrated posture information. The controller 12 can be said to generate the integrated information or integrated posture information by integrating the reference information or reference posture information.

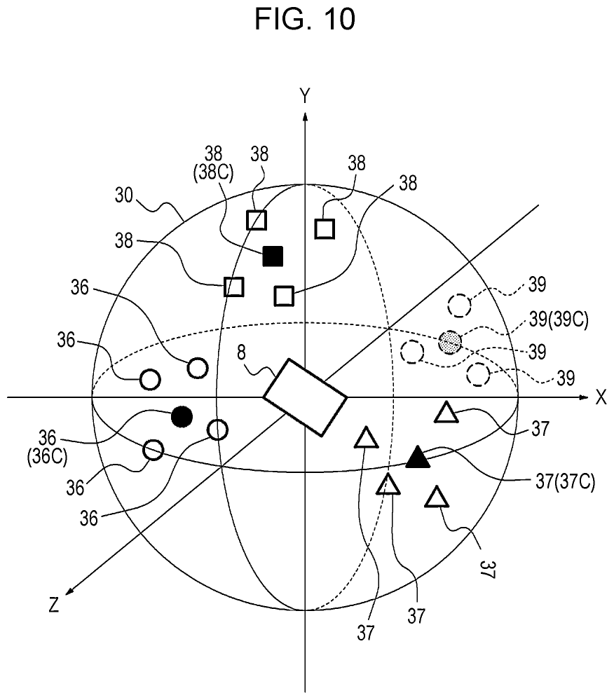

Let us assume that points 36, points 37, points 38, and points 39 corresponding to posture information are positioned on the information acquisition sphere 30, as illustrated in FIG. 10. The points 36 are represented by solid-line circles. The points 37 are represented by solid-line triangles. The points 38 are represented by solid-line squares. The points 39 are represented by dashed-line circles indicating that the circles are positioned behind the information acquisition sphere 30. In this example, the controller 12 may cluster the points 36, the points 37, the points 38, and the points 39 into different clusters. The controller 12 may perform clustering of points corresponding to the posture information based on various algorithms such as the k-means method or a mixed Gaussian model.

The controller 12 may determine a point 36C to represent the cluster from among the five points 36 clustered into one cluster. The controller 12 may combine the points included in the cluster into one point by deleting the four points 36C other than the point 36C from the database 20. The point 36C is represented by a black circle. The controller 12 may determine points 37C, 38C, and 39C representing corresponding clusters in the same manner for the other clusters. The point 37C is represented by a black triangle. The point 38C is represented by a black square. The point 39C is represented by a shaded dashed-line circle. The controller 12 may combine the points in each cluster into a single point by deleting the points 37, 38, and 39 from the database 20, except for the points 37C, 38C, and 39C, which represent the corresponding clusters. Reference information registered in the database 20 is organized in this way. Organizing the reference information can reduce the burden of processing for checking reference information in the database 20.

The controller 12 may perform the integration processing so that differences in the density of the integrated posture information are reduced by the integration processing. The controller 12 may execute the integration processing so that the density distribution of the reference information after the integration processing is uniform. The controller 12 may perform the integration processing so that differences in distance between two points that represent the integrated posture information on the information acquisition sphere 30 is reduced by the integration processing. In this way, object information that is similar to the recognition information is more likely to remain on the information acquisition sphere 30.

The controller 12 may perform the integration processing when the number of pieces of reference posture information contained in the reference information of an object exceeds an integration determination threshold. The controller 12 may perform the integration processing when the density of points representing multiple pieces of reference posture information contained in the reference information of an object on the information acquisition sphere 30 exceeds a density determination threshold. The integration determination threshold or density determination threshold may be set, for example, based on the data capacity of the database 20 or the computing load required by the controller 12 to check reference information in the database 20.

In other words, the controller 12 may perform the integration processing when the number or density of pieces of reference posture information satisfies an integration condition. The integration condition is considered to be satisfied when the number of pieces of reference posture information exceeds the integration determination threshold, or when the density of points representing the pieces of reference posture information on the information acquisition sphere 30 exceeds the density determination threshold. Integration conditions can be set so that the integration of reference information can be performed in a timely manner.

### Examples of Other Procedures of Robot Control Method

The controller 12 may execute a robot control method that includes the following procedures.

### When there are No Entries at All in Database 20

If the category of the holding target 8 is not registered in the database 20, the controller 12 estimates the holding manner using the inference model. The controller 12 controls the robot 2 so that the end effector 2B is made to hold the holding target 8 in the estimated holding manner. The controller 12 extracts feature amounts from the recognition information of the holding target 8. The controller 12 acquires the position or direction from which the recognition information was acquired, or posture information representing the posture of the holding target 8. The controller 12 registers reference information that associates the holding manner information, which specifies the estimated holding manner, with the acquired posture information in the database 20. In this case, the controller 12 registers the acquired posture information in the database 20 as base posture information.

### When there are Sufficient Entries in Database 20

If the category of the holding target 8 is registered in the database 20, the controller 12 checks the reference information registered in the database 20 for the recognition information of the holding target 8 and searches for matching or similar object information. The controller 12 extracts feature amounts of the holding target 8.

The controller 12 estimates the posture information of the holding target 8. For example, the controller 12 extracts feature amounts of the holding target 8. The controller 12 may estimate the posture information that specifies the position or direction from which the recognition information was acquired by searching for feature amounts that match or are similar to the extracted feature amounts. The controller 12 searches for object information that matches or is similar to the estimation result of the posture information of the holding target 8. When the controller 12 finds object information that matches the posture information of the holding target 8, the controller 12 estimates the manner specified by the holding manner information associated with that object information as the holding manner of the holding target 8. When the controller 12 finds object information that includes reference posture information in the vicinity of the posture information of the holding target 8, the controller 12 may generate and acquire holding manner information by performing interpolation for holding manner information in the posture information of the holding target 8 based on the holding manner information associated with the reference posture information. When the controller 12 finds object information that includes reference posture information in the vicinity of the posture information of the holding target 8, the controller 12 may acquire the holding manner information associated with the reference posture information as the holding manner information of the posture information of the holding target 8. If the holding manner information associated with the reference posture information is used as is, the holding target 8 may be held at an angle because the holding target 8 will be held based on posture information different from the posture information of the holding target 8.

The controller 12 controls the robot 2 so that the end effector 2B is made to hold the holding target 8 in the holding manner specified by the acquired holding manner information. The controller 12 estimates the holding state based on detection results of the sensors of the robot 2 and determines whether holding was successfully performed. If the holding was successful, the controller 12 may register, in the database 20, object information in which the posture information and feature amounts, etc., of the holding target 8 are associated with the holding manner information. If the holding target 8 was held using holding manner information that had already been registered, the controller 12 may update the success rate associated with the holding manner information based on the holding results.

### When there are Entries in Database 20 but Not Sufficient Entries

If the category of the holding target 8 is registered in the database 20, the controller 12 checks the reference information registered in the database 20 for the recognition information of the holding target 8 and searches for matching or similar object information. The controller 12 extracts feature amounts of the holding target 8. The controller 12 estimates posture information that specifies the position or direction from which the recognition information was acquired by searching for feature amounts that match or are similar to the extracted feature amounts. In this example, let us assume that the recognition information of the holding target 8 is neither identical to nor similar to the reference information in the database 20. For example, when the feature amounts of only the front surface of an object are registered in the database 20, if the feature amounts included in the recognition information are those of the rear surface of the object, these feature amounts will neither match nor be similar to the feature amounts registered in the database 20. In this case, the controller 12 will be highly unlikely to be able to estimate posture information using the feature amounts and will be highly unlikely to be able to extract holding manner information using the feature amounts of the recognition information. Therefore, the controller 12 will estimate the holding manner using the inference model. The controller 12 may determine whether to use the inference model based on the degree of agreement between the feature amounts of the recognition information and the feature amounts of the reference information.

The controller 12 estimates the holding manner using the inference model. The controller 12 controls the robot 2 so that the end effector 2B is made to hold the holding target 8 in the estimated holding manner. The controller 12 extracts feature amounts from the recognition information of the holding target 8.

If the recognition information and the reference information do not match at all, specifically, if the feature amounts of the recognition information and the feature amounts of the reference information do not match at all (when the degree of matching is extremely low or the degree of matching is less than a first lower limit), the controller 12 cannot estimate the holding manner from the reference information registered in the database 20. Therefore, the controller 12 tentatively generates new base posture information as posture information that is not similar to the existing base posture information. Specifically, the controller 12 tentatively generates base posture information corresponding to a position that is not similar to that of the base posture information of a first point included in the reference information on the information acquisition sphere 30 and registers the generated base posture information in the database 20. The non-similar position may be a position on the opposite side, for example. The controller 12 may fine-tune the tentatively generated posture information based on posture information acquired in a later operation.

When the recognition information and the reference information match to a certain degree, specifically, when the feature amounts of the recognition information and the feature amounts of the reference information match to a certain degree extent (when the degree of matching is greater than or equal to the first lower limit and less than a second lower limit), the controller 12 can estimate the posture information from the reference information registered in the database 20 with a low accuracy. The controller 12 generates the posture information estimated with low estimation accuracy as provisional normal posture information and registers the generated posture information in the database 20. The controller 12 may fine-tune the tentatively generated posture information based on posture information acquired in a later operation.

The controller 12 may fine-tune the provisional posture information after generating multiple pieces of provisional base posture information or provisional normal posture information. The controller 12 may fine-tune the posture information using a method in which surrounding image-capturing points are used. The controller 12 may fine-tune the estimation result of the posture information using a method in which all image-capturing points are used. In this case, for example, the controller 12 may fine-tune the positional relationships on the information acquisition sphere 30 in accordance with the degree of similarity with posture information located in the vicinity of that posture information among the pieces of posture information registered tin the database 20.

An embodiment of the robot control device 10 has been described above. Embodiments of the present disclosure can be a method or program for implementing a device, as well as a storage medium on which a program is recorded (for example, an optical disk, an optical-magnetic disk, a CD-ROM, CD-R, CD-RW, magnetic tape, hard disk, or memory card, and so on.).

The embodiment of a program is not limited to an application program such as object code compiled by a compiler or program code executed by an interpreter, and can also take the form of a program module or the like incorporated into an operating system. Furthermore, the program may be or not be configured so that all processing is performed only in a CPU on a control board. The program may be configured to be implemented entirely or partially by another processing unit mounted on an expansion board or expansion unit added to the board as necessary.

Although embodiments of the present disclosure have been described based on the drawings and examples, please note that one skilled in the art can make various variations or changes based on the present disclosure. Please note that, therefore, these variations or changes are included within the scope of the present disclosure. For example, the functions and so on included in each constituent part can be rearranged in a logically consistent manner, and multiple constituent parts and so on can be combined into one part or divided into multiple parts.

All of the constituent elements described in the present disclosure and/or all of the disclosed methods or all of the steps of disclosed processing can be combined in any combination, except for combinations in which their features would be mutually exclusive. Each of the features described in the present disclosure may be replaced by alternative features that serve the same, equivalent, or similar purposes, unless explicitly stated to the contrary. Therefore, unless explicitly stated to the contrary, each of the disclosed features is only one example of a comprehensive set of identical or equivalent features.

Furthermore, the embodiments according to the present disclosure are not limited to any of the specific configurations of the embodiments described above. The embodiments according to the present disclosure can be extended to all novel features, or combinations thereof, described in the present disclosure, or all novel methods, or processing steps, or combinations thereof, described in the present disclosure.

In the present disclosure, “first”, “second,” and so on are identifiers used to distinguish between such configurations. Regarding the configurations, “first”, “second”, and so on used to distinguish between the configurations in the present disclosure may be exchanged with each other. For example, identifiers “first” and “second” may be exchanged between the first candidate manner 41 and the second candidate manner 42. Exchanging of the identifiers take places simultaneously. Even after exchanging the identifiers, the configurations are distinguishable from each other. The identifiers may be deleted. The configurations that have had their identifiers deleted are distinguishable from each other by symbols. Just the use of identifiers such as “first” and “second” in this disclosure is not to be used as a basis for interpreting the order of such configurations or the existence of identifiers with smaller numbers.

### REFERENCE SIGNS

1 robot control system (2: robot, 2A: arm, 2B: end effector, 4: information acquiring unit, 5: robot operation range, 6: work start bench, 7: work destination bench)
8 holding target (8A: feature point)
10 robot control device (12: controller, 14: interface)
20 database
30 information acquisition sphere (31 to 39, 36C to 39C: point)
41 to 43 first to third candidate manner

1. A robot control device comprising:
a controller configured to be capable of estimating a holding manner of a holding target using each of a database and an interference model and to control a robot based on the estimated holding manner, the database containing reference information including object information of multiple objects and holding manner information of the multiple objects and the inference model being capable of estimating a holding manner of an object,
wherein the controller acquires recognition information of a holding target, and
when the controller determines that the holding manner of the holding target cannot be estimated from the database based on the recognition information, the controller estimates the holding manner using the inference model.

2. The robot control device according to claim 1,
wherein the controller
searches the database for object information similar to the recognition information, and
is capable of extracting a holding manner associated with the object information found in the search.

3. The robot control device according to claim 1,
wherein the reference information includes category information indicating a category of each of multiple objects, and
the controller acquires the category information of the holding target, and
is capable of estimating the holding manner from the database based on the object information containing the category information.

4. The robot control device according to claim 1,
wherein the reference information includes category information indicating a category of each of multiple objects, and
the controller acquires the category information of the holding target, and
estimates the holding manner of the holding target using the inference model when the category information is not registered in the database.

5. The robot control device according to claim 1,
wherein the reference information includes posture information for each of the multiple objects and holding manner information associated with the posture information,
the controller acquires the posture information of the holding target as the recognition information, and
estimates the holding manner based on the posture information of the holding target.

6. The robot control device according to claim 1,
wherein the controller estimates the holding manner based on at least one piece of holding target information associated with reference posture information similar to the posture information of the holding target.

7. The robot control device according to claim 6,
wherein the controller estimates the holding manner based on multiple pieces of holding manner information, each of which are associated with reference posture information similar to the posture information.

8. The robot control device according to claim 7,
wherein one piece of the reference posture information is associated with multiple pieces of holding manner information, and
the controller selects the holding manner information based on an associated holding performance from among the multiple pieces of holding manner information.

9. The robot control device according to claim 7,
wherein when the controller estimates the holding manner from the inference model, the controller can register an estimation result in the database.

10. The robot control device according to claim 9,
wherein when the holding target is successfully held by controlling the robot based on the estimation result of the holding manner, the controller generates reference information in which the holding manner information representing the successful holding manner and the object information of the successfully held holding target are associated with each other, and registers the generated reference information in the database.

11. The robot control device according to claim 7,
wherein the controller is capable of performing integration processing of integrating at least two pieces reference posture information from among of the multiple pieces of reference posture information registered in the database.

12. The robot control device according to claim 11,
wherein the controller performs the integration processing, the integration processing making a difference in density of integrated posture information generated by the integration processing smaller.

13. The robot control device according to claim 11,
wherein the controller performs the integration processing when a number or density of the multiple pieces of reference posture information satisfies an integration condition.

14. The robot control device according to claim 1,
wherein when no object information similar to the recognition information is registered in the database, the controller estimates the holding manner of the holding target using the inference model.

15. A robot control method comprising:
a robot control device acquiring recognition information of a holding target, the robot control device configured to be capable of estimating the holding manner of the holding target using each of a database and an interference model and to control a robot based on the estimated holding manner, the database containing reference information including object information of multiple objects and holding manner information of the multiple objects and the inference model being capable of estimating a holding manner of an object, and
the robot control device estimating the holding manner using the inference model when the robot control device determines that the holding manner of the holding target cannot be estimated from the database based on the recognition info
